(19) United States
(12) Patent Application Publication
(10) Pub. No.: US 2024/0367325 A1
(43) Pub. Date: Nov. 7, 2024

(54) AUTOMATED TOOLING ATTACHMENT

(71) Applicant: Lab2Fab, LLC, Fremont, CA (US)

(72) Inventor: Samuel Lewis Tanaka, San Leandro, CA (US)

(21) Appl. No.: 18/650,061

(22) Filed: Apr. 29, 2024

Related U.S. Application Data
(60) Provisional application No. 63/464,308, filed on May 5, 2023.

(51) Int. Cl. B25J 11/00; B25J 15/00; B25J 19/00

(52) U.S. Cl. CPC B25J 11/0045; B25J 15/0028; B25J 19/0075

(57) ABSTRACT

Example apparatuses are directed to an automated tooling having a plurality of assembled components including at least one moving component. The plurality of assembled components define one or more openings. The apparatus further includes an attachment comprising a plurality of surfaces, each of a single piece of material, wherein each of the plurality of surfaces is configured to directly interface with and cover a component of the automated tooling. A first surface of the plurality of surfaces is configured to cover the at least one moving component, and a second surface of the plurality of surfaces is configured to cover one or more of the openings defined by the automated tooling. The attachment defines at least one attachment opening that allows the plurality of surfaces to be removably attached to the automated tooling such that the plurality of surfaces directly interface and cover the components of the automated tooling.

### CROSS-REFERENCE TO RELATED APPLICATIONS

This application claims the benefit of U.S. Provisional Patent Application No. 63/464,308 filed May 5, 2023, the disclosure of which is hereby incorporated by reference herein in its entirety for all purposes.

### INTRODUCTION

The present disclosure is directed to apparatuses, systems, and methods for cooking consumable items, and more particularly, to an attachment for covering a robotic device for use in an automated cooking system.

### BACKGROUND

Robotic automated food preparation systems have been developed for automating various kitchen operations of a restaurant. Each of U.S. patent application Ser. No. 17/494,664 (filed on Oct. 5, 2021) and U.S. Provisional Patent Application Ser. No. 63/088,162 (filed on Oct. 6, 2020) disclose examples of robotic automated food preparation systems that may be used to fry consumable items such as French fries, onion rings, chicken, and other related consumable items.

It is generally desired that automated cooking systems comply with cleanability and sterilization standards or requirements. In some robotic automated fryer systems, a robotic arm may be employed to move consumable items from a storage container or cabinet to a cooking medium, e.g., of a fryer. The robotic arm may have a variety of moving components assembled in a manner that creates gaps, cavities, or the like that may capture food particles, cooking medium, or the like and may be relatively difficult to clean or otherwise comply with relevant standards.

### SUMMARY

In at least some examples, an attachment for automated tooling comprises a plurality of surfaces, each of a single piece of material. Each of the plurality of surfaces is configured to directly interface with and cover a component of the automated tooling. A first surface of the plurality of surfaces is configured to cover one or more moving components of the automated tooling, and a second surface of the plurality of surfaces configured to cover one or more openings of the automated tooling. At least one attachment opening allows the plurality of surfaces to be removably attached to the automated tooling such that the plurality of surfaces directly interface and cover the components of the automated tooling.

In at least some example approaches, an automated tooling is provided having a plurality of assembled components that includes at least one moving component. The plurality of assembled components define one or more openings. The apparatus further includes an attachment comprising a plurality of surfaces, each of a single piece of material, wherein each of the plurality of surfaces is configured to directly interface with and cover a component of the automated tooling. A first surface of the plurality of surfaces is configured to cover the at least one moving component, and a second surface of the plurality of surfaces is configured to cover one or more of the openings defined by the automated tooling. The attachment defines at least one attachment opening that allows the plurality of surfaces to be removably attached to the automated tooling such that the plurality of surfaces directly interface and cover the components of the automated tooling.

In at least some examples, a method of designing an attachment for an automated tooling comprises identifying a first plurality of components of the automated tooling that are required to be covered, and identifying a second plurality of components of the automated tooling that are not required to be covered. The method further includes designing a single piece attachment that directly interfaces with and covers the first plurality of components. The single piece attachment does not directly interface and cover at least some of the second plurality of components. The method may also include selecting a material suitable for attachment of the single piece attachment over the first plurality of components, and defining an opening for the single piece attachment to be attached over the first plurality of components.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1A depicts a perspective view of an end of arm tooling (EOAT), e.g., for a robotic arm in an automated cooking system, in accordance with some embodiments of the disclosure;

FIG. 1B depicts a perspective view of the end of arm tooling of FIG. 1A with a basket handle received for gripping by the end effector, in accordance with some embodiments of the disclosure;

FIG. 1C depicts a perspective view of the end of arm tooling of FIGS. 1A and 1B with the basket handle enclosed within and gripped by the end effector, in accordance with some embodiments of the disclosure;

FIG. 2A depicts a front upper perspective view of an attachment assembled over the end of arm tooling of FIGS. 1A-1C, in accordance with some embodiments of the disclosure;

FIG. 2B depicts a rear lower perspective view of the attachment and end of arm tooling of FIG. 2A, in accordance with some embodiments of the disclosure;

FIG. 3 is a lower perspective view of the attachment of FIGS. 2A and 2B, illustrated before assembly to an end of arm tooling, in accordance with some embodiments of the disclosure;

FIG. 4 depicts a perspective view of an automated cooking system comprising a robotic arm having an end of arm tooling and attachment, in accordance with some embodiments of the disclosure; and

FIG. 5 is a flow chart representing an illustrative method of designing an attachment for an automated tooling, in accordance with some embodiments of the disclosure.

### DETAILED DESCRIPTION

Example illustrations herein are generally directed to systems and methods that provide automated food preparation (e.g., as executed by at least one robotic apparatus) including handling of food items or conveyances (e.g., fryer baskets, trays, grabbers, and other tools) using automated equipment such as a robotic arm having end-of-arm tooling. Although the present disclosure is described in the context of an automated frying system facilitated with one or more robot arms as food preparation devices, the automated tooling attachment described in the present disclosure may be utilized with other automated components to perform other food preparation operations. Merely by way of example, automated tooling attachments may be employed to cover openings and/or moving components of automated tooling in any cooking system, e.g., to facilitate dispensing, cooking, and movement of bulk food items.

Generally, in at least some automated cooking systems mechanical devices are used for various tasks, such as gripping and releasing items that are moved within the system, e.g., a handle for a fryer basket. Mechanical apparatuses for gripping may offer advantages in terms of a deep draw area for “picking” items and facilitate “blind” picking of items without use of a camera, optical sensor, or other means for visually confirming location of an object being gripped or moved. These mechanical-based apparatuses may be relatively difficult to clean or maintain food-safe conditions, at least in comparison to systems where pneumatics or other relatively “smooth” components are employed that may be easier to clean. Furthermore, known approaches to covering or protecting mechanical apparatuses and moving components are typically difficult to remove or may get in the way of operation.

Example automated systems described herein facilitate the safe, clean, cost-effective, and timely performance of bulk or specialized food preparation operations by utilizing robotic equipment and other automated features to perform food preparation operations that may otherwise create substantial issues of operator safety, ergonomics, and cleanliness. For example, standards setting bodies such as the National Sanitation Foundation (NSF) have strict standards for ensuring that any equipment that interfaces with food or drink items meet certain design standards for sanitation, cleanliness, and case of use/cleaning. In one such example, devices and equipment utilized in food handling and preparation processes must have food safe materials and coatings and sanitary machine designs. In the context of equipment and tools that are directly handled by an employee operator, relatively simple tools and interfaces can be developed that, when coupled with the natural dexterity of the operator, inherently comply with such standards. When automation is added to the food preparation and service environment, complex movements and tooling (e.g., end-of-arm tooling) may require a variety of complex components to engage in movements with adequate speed and precision to perform the necessary operations. Miniaturized components, actuators, articulating wrists, pulleys, grippers, slots, holes, pockets, fasteners, sensors, electrical connectors, and seams may be necessary or desirable to perform particular operations. These components may present sharp transitions, open gaps, or other external features that present challenges to regular cleaning and/or sterilization.

Accordingly, in examples herein an attachment may be provided that includes a plurality of surfaces each of a single piece of material, with each of the surfaces being configured to directly interface with and cover one or more components of the automated tooling. As a result, the components covered by the attachment may be prevented from contacting food particles or cooking mediums such as oil during operation of the automated tooling. While the attachment may present relatively smooth outer surfaces that facilitate cleaning while installed on the automated tooling, the attachment may be removed from the automated tooling to allow independent cleaning. For example, the attachment may be cleaned or sterilized in a washing machine or the like.

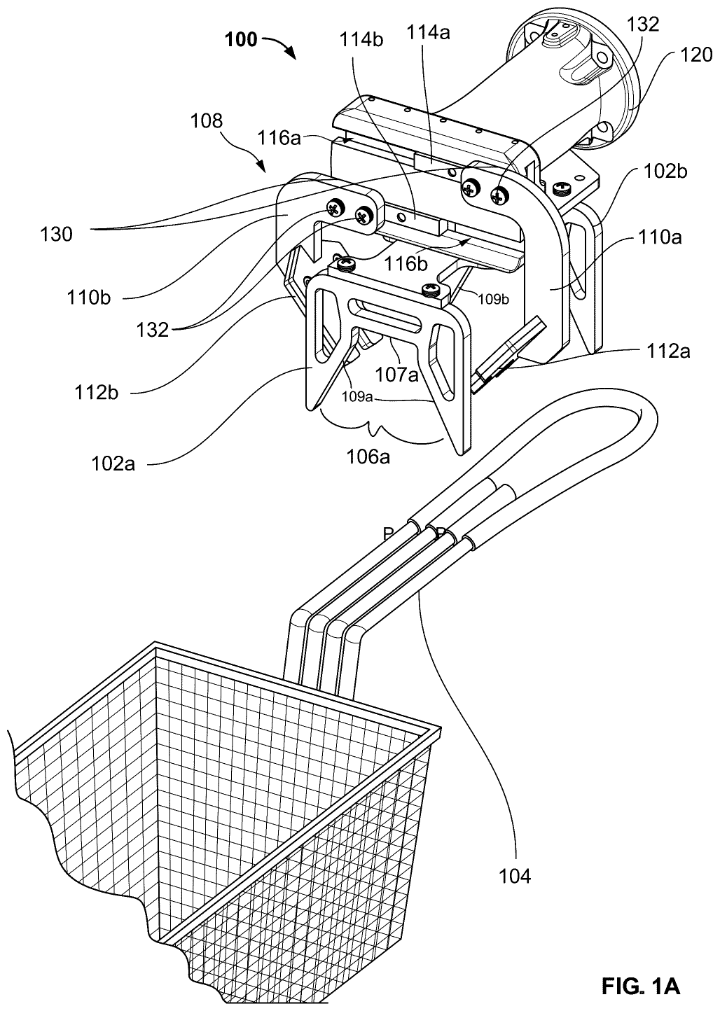

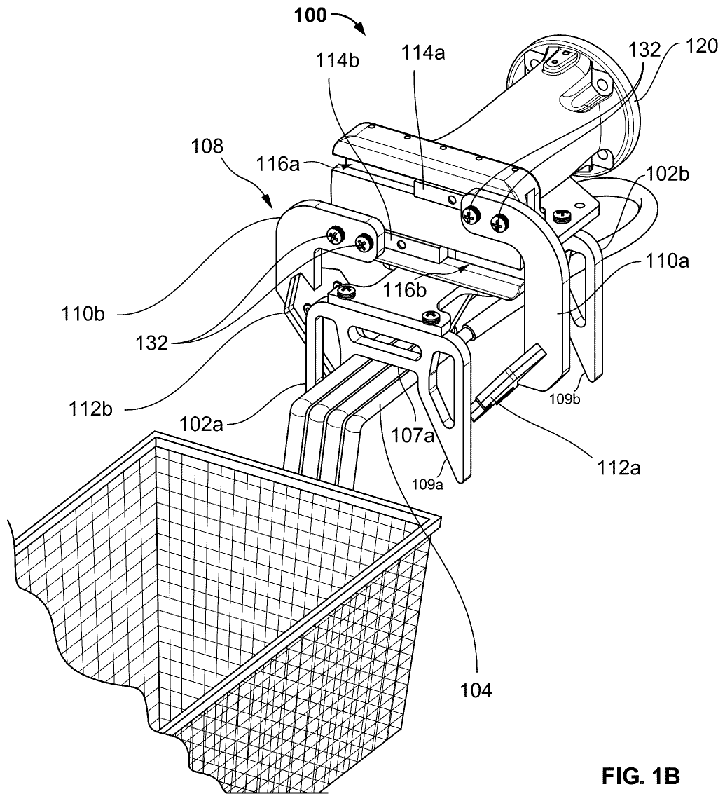

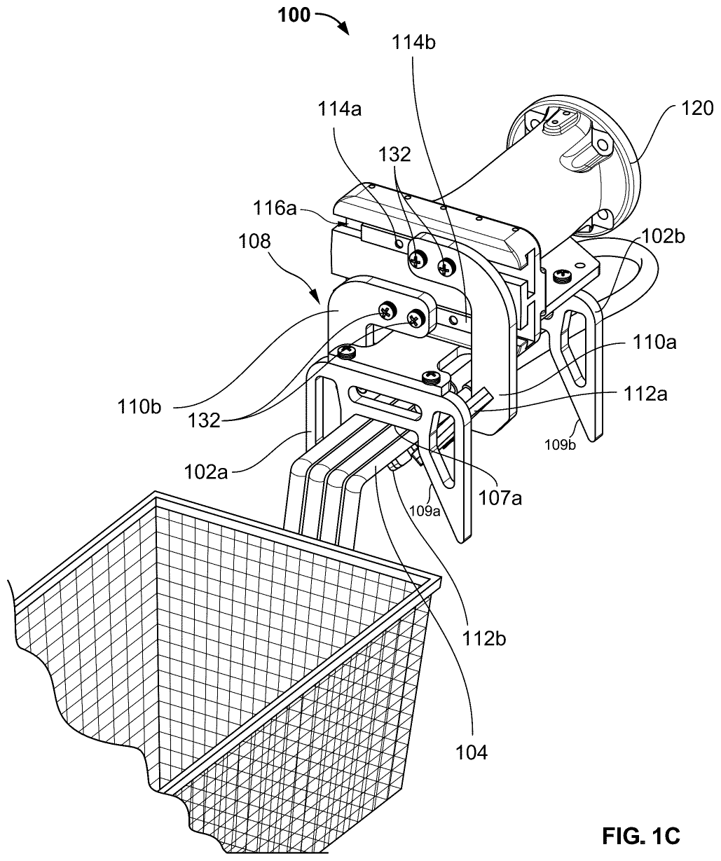

Referring now to FIGS. 1A-1C, an exemplary end-of-arm tooling 100, e.g., for a robotic frying system, is illustrated in accordance with the present disclosure. The example tooling 100 is a gripper comprising a plurality of extensions 102 configured to receive an elongate handle 104 of a fryer basket or, for that matter, any other elongate member that may be convenient. The extensions 102 may include a first extension 102a defining a first handle opening 106a and a second extension 102b defining a second handle opening 106b. The first handle opening 106a defined by the first extension 102a is relatively wide, and narrows to a clamp surface 107a of the first extension 102a, and against which the handle 104 may be clamped, e.g., as described further below. Similarly, the second handle opening 106b defined by the second extension 102b is relatively wider than a clamp surface 107b of the second extension 102b. Additionally, a gripper assembly 108 may be provided that is configured to grip or enclose the handle 104 (or, for that matter, any other elongated member) within the first handle opening 106a and the second handle opening 106b. The gripper assembly 108 may include an upper support arm 110a carrying a first lateral grip 112a, and a lower support arm 110b carrying a second lateral grip 112b. The support arms 110a and 110b are each fixed to respective slides 114a and 114b. A rear flange 120 of the tooling 100 may be secured to a multi-axis robot arm (not shown in FIGS. 1A-1C). Accordingly, the second extension 102b may be arranged rearward of the first extension 102a with respect to the free end of the tooling, i.e., opposite the rear flange 120.

The slides 114a and 114b each move laterally within respective tracks 116a and 116b formed at a front face 118 of the tooling 100, thereby moving the lateral grips 112a and 112b together or apart. As illustrated in FIG. 1A, the lateral grips 112a and 112b are shown initially in a separated position. The tooling 100 may be moved downward toward the handle, thereby receiving the handle 104 within the openings 106a and 106b of the first extension 102a and the second extension 102b, respectively, as shown in FIG. 1B. The relatively wide openings 106a and 106b and ramp surfaces 109a and 109b of the extensions 102 allow the tooling 100 to receive the handle 104 while the tooling 100 is moved, e.g., using a robot arm. Accordingly, the tooling 100 has a significant positional tolerance with respect to gripping the handle 104 or other elongate objects. For example, when the basket is received in a fryer in an automated cooking system (not shown in FIGS. 1A-1C), the handle 104 may become warped, bent, or damaged over time and as such the handle 104 may not be positioned in an expected position. However, relatively wide openings 106 and ramp surfaces 109 may nevertheless guide the handle 104 into a position within the first extension 102a and second extension 102b, allowing the handle 104 to be gripped by the lateral grips 112a and 112b. Accordingly, as shown in FIG. 1C, after the handle 104 is received within the openings 106 of the extensions 102, the lateral grips 112a and 112b may be moved toward each other, thereby clamping the handle 104 against the clamp surfaces 107a and 107b of the extensions 102a and 102b, respectively. The handle 104 is thereby resiliently carried by the tooling 100 and as such may be manipulated within an automated cooking system to collect bulk food items such as French fries, chicken nuggets, or the like for cooking, to dump the contents of the basket, etc. Subsequently, the basket may be placed where desired by the robot, and the tooling 100 may release the handle 104 by moving the lateral grips 112 apart, thereby releasing the handle 104 and allowing the tooling 100 to be moved away from the handle 104 and/or the basket.

As noted above, the lateral grips 112a and 112b may be translated toward each The slides 114 may be actuated using any arrangement that is convenient. For example, one or more internal gear(s) may be engaged with corresponding teeth (not shown) of the slides 114 to move the slides 114 together or apart depending on the direction of rotation. In other example approaches, the slides 114 are magnetically, electrically or pneumatically actuated, or by way of a spring-loaded mechanism, a cam/latch arrangement, or a toggle. In any case, as will be discussed below the slides 114 and other movable components of the tooling 100, as well as the robot arm carrying the tooling 100, may be actuated and controlled by a processor and memory (not shown in FIGS. 1A-1C). For example, an automated cooking system in which the tooling 100 and/or the handle 104 is present may comprise a robotic arm and processing circuitry configured to interface with the tooling 100 and components thereof, e.g., the gripper assembly 108. With the handle enclosed and trapped against the base of the first extension and the second extension, the basket is securely held by the manipulator, and the basket may be moved, e.g., to place the basket in a fryer or other cooking device, remove the basket from a frying medium, remove the basket from the cooking device, etc.

In some examples, components of the tooling 100 may be formed of aluminum, such as the first extension 102a, the second extension 102b, the support arms 110, lateral grips 112, etc. Alternatively, components of the tooling 100 may be formed of a food-safe plastic.

As depicted in FIGS. 1A-1C, the automated tooling 100 (e.g., end-of-arm tooling) has a variety of moving components and open spaces for performing necessary operations (e.g., grabbing, translating, etc.) and/or interfacing with other components (e.g., removable attachments, robot arms, or other moving and/or articulating food preparation components, such as conveyors, racks, trays, ovens, food preparation stations, food storage locations, food service areas, etc.). The components of the automated tooling may be optimized to perform operations consistently, efficiently, quickly, and with a long useful life. However, as depicted in the exemplary end-of-arm tool 100 of FIGS. 1A-1C, the resulting mechanical and/or electromechanical design may have multiple locations or components in which food particles or food preparation materials (e.g., fry oil) may become situated with difficult access for cleaning or sterilization.

For example, as depicted in FIGS. 1A-1C, in order for automated tooling 100 to grab and manipulate handle 104 or other features of a basket, the tooling 100 has multiple moving parts that require mechanical connections to each other. Merely by way of example, the slides 114 move within tracks 116 that are generally open toward a front side of the tooling 100 adjacent the basket/handle 104. Additionally, as illustrated in FIGS. 1A-IC the support arms 110 are secured to the slides 114 with threaded members (e.g., bolts). The support arms 110 may thereby be secured against the slides 114, with a relatively small seam 130 present between the support arm 110 and the slide 114 to which it is secured. Additionally, the threaded members or other fasteners may have one or more recesses 132 to facilitate tightening/loosening, e.g., a cross-shaped recess configured to receive a Phillips-type driver, as illustrated. The tooling 100 may also have a variety of sensors (not shown in FIGS. 1A-1C), e.g., for detecting force, temperature, or any other parameter that may be desired to facilitate operation of the tooling 100, which may require ports or other openings on the outer surface(s) of the tooling 100. Additionally, the tooling 100 may have a blind pocket, i.e., a recess or opening that is not easily visible or accesses, in or between components of the tooling 100. These are merely examples, and there are other relatively complex geometries and surface topographies illustrated in the tooling 100 creating holes, pockets, and seams that can harbor bacteria and contaminants, making the exposed tooling 100 a food safety concern in a kitchen environment. Moreover, the front side of the tooling 100 in which the tracks 116, seams 130, and recesses are present is typically closest to frying mediums such as hot oil, and thus prone to being splattered with oil. Covering these features in the tooling 100 must be done in a way that does not inhibit the mechanical motion of the tooling 100, shields the areas that could harbor bacteria, and is easily removable for cleaning.

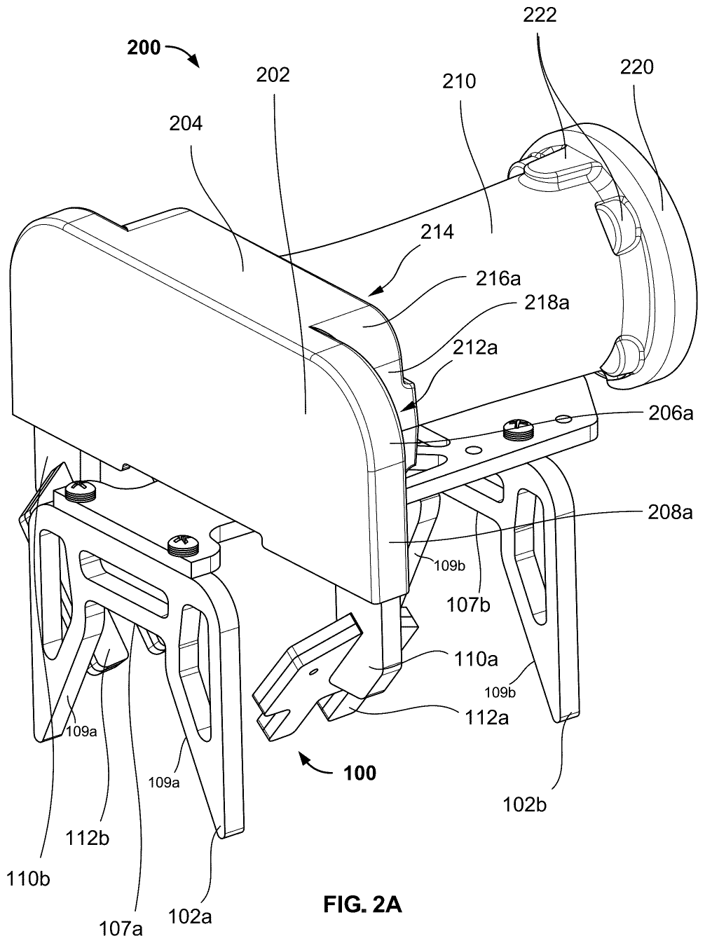

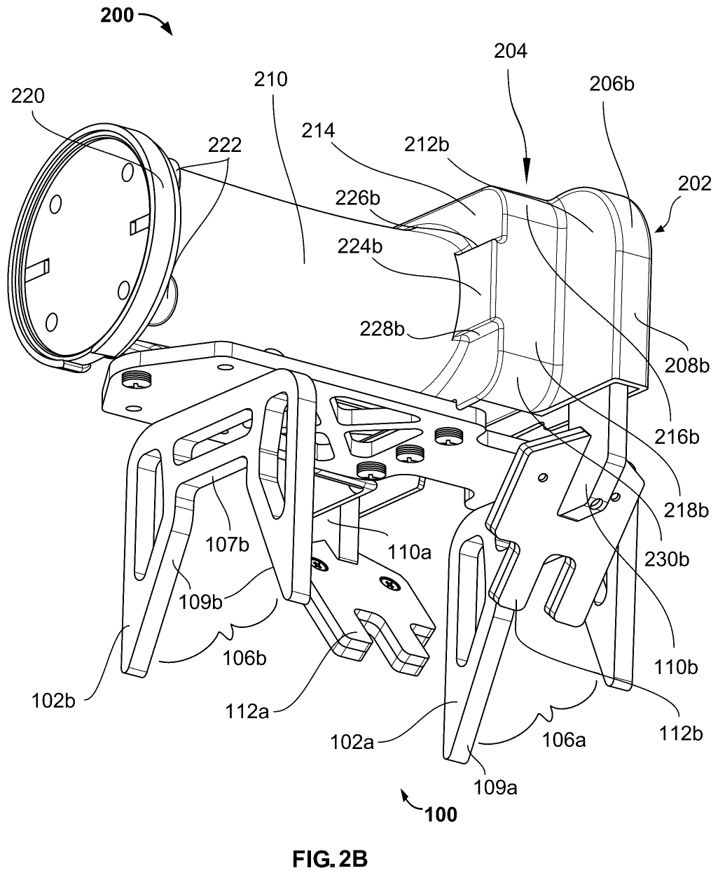

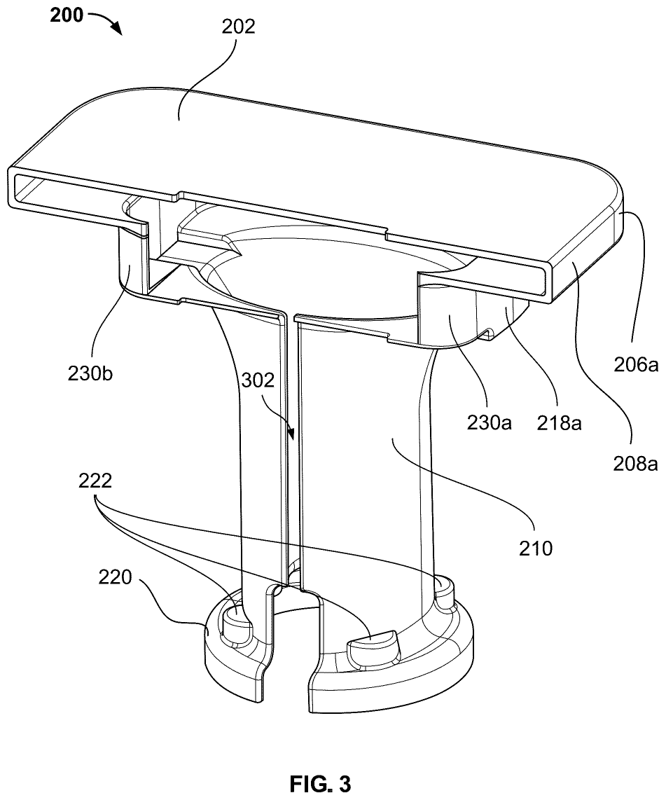

Referring now to FIGS. 2A, 2B, and 3, an exemplary automated tooling attachment 200 is illustrated and described in further detail, in accordance with the present disclosure. As depicted in FIGS. 2A and 2B, the attachment 200 may be formed of a flexible elastomer material, such that the attachment 200 allows for a tight fit around the complex geometry of the tooling 100. The high flexibility of the material facilitates its installation by being elastically stretched over the tooling 100, while returning to its initial state to hold itself in place. The elastomer material has a plurality of surfaces that are collectively smooth and seamless, such that the attachment is easy to clean and has no exposed voids that can harbor bacteria when assembled to the tooling 100. The automated tooling attachment 200 may be fabricated in a variety of suitable manners such as 3D printing or molding, merely as examples. 3D printing or similar processes (e.g., additive manufacturing) may generally permit a tight fit to the moving parts of the tooling 100, e.g., the supports 110 and slides 114, without hindering the motion or functionality. The automated tooling attachment of FIGS. 2A, 2B, and 3 depicts an elastomer material fabricated by 3D printing, however it will be understood that a variety of materials and manufacturing processes can be used to create an automated tooling attachment for different purposes and applications. For example, flexible materials may include a flexible elastomer, resins, polymer, silicon, thermoplastics, rubbers, thermoplastic polyurethane (TPU), or other similar materials. 3D printing and similar additive technologies may facilitate formation of relatively complex geometries that may be difficult or cost prohibitive to produce using conventional techniques such as molds and tooling. In the illustrated example of FIGS. 2A, 2B, and 3, the attachment 200 is formed in a unitary monolithic piece from a high-temperature resistant and flexible food-grade silicone material. In some implementations, one or more components of the attachment 200 may be rigid, for example, for a clamshell design or a component that couples a scam of a flexible component. The attachment 200 may be thickened or thinned in certain areas of the attachment 200 relative to other areas of the attachment 200 to provide desired performance. Merely by way of example, the annular surface 220 of the attachment 200 may be made relatively thicker to promote a “snap” of the attachment 200 onto the tooling 100 and promote retention of the attachment 200 on the tooling 100. Alternatively or in addition, other areas may be thinned to facilitate installation and removal. Thickening or thinning of areas may be relatively easy to execute where the attachment 200 is formed in an additive process such as 3D printing, or by molding. Further, thinning of the attachment 200 in desired areas may also be accomplished by mechanical removal processes such as cutting.

The automated tooling attachment 200 generally facilitates the isolation of complex geometries into one or a limited set of components that cover and protect the automated tooling 100, preventing the interaction of food particles or food preparation consumables with certain surfaces of the automated tooling 100. In some instances, the tooling attachment may be designed to completely cover the automated tooling, for example, as a flexible balloon-type attachment that fully covers an end-of-arm tool of a robot. In some instances processing may be applied to the tooling attachment to facilitate close engagement with the surfaces of the tooling, such as a heat shrink or other similar methodology. It will be noted that not all surfaces of automated tooling may be required to be covered. For example, as shown in FIGS. 2A and 2B, relatively more smooth and easily accessible surfaces of the tooling such as the lateral grips 112a and 112b, lower portions of the supports 110, and the extensions 102a and 102b, may be suitably cleaned and sterilized in accordance with best practices such as NSF standards. Thus, as will be discussed further below, a design process for creating the automated tooling attachment may tag or otherwise identify certain surfaces as being suitable for contact with the food preparation/service environment and thus not required to be covered by the automated tooling attachment 200. Moreover, while the illustrated example shows a generally continuous upper surface of the attachment 200 that shields an entire upper portion of the tooling 100, in other approaches the automated tooling attachment 200 may include access ports, inserts, windows, and the like within outer surfaces of the attachment to facilitate sensors or other similar components of automated tooling.

The attachment 200, as noted above, generally defines a continuous outer surface that interfaces with and covers a plurality of moving components of the tooling 100, as well as voids, openings, or seams in the tooling 100, e.g., as noted above. As seen in FIG. 2A, the outer surface of the attachment 200 comprises a frontal planar surface 202, upper planar surface 204, a left lateral curved surface 206a, and a left lateral planar surface 208a along a front region of the attachment 200. The attachment 200 further includes rearward-facing planar surfaces 212a and 214. The attachment 200 further includes a second lateral curved surface 216a and second lateral planar surface 218a positioned in between the rearward-facing planar surfaces 212a and 214. A cylindrical surface 210 extends from the rearward-facing planar surface 214 to an annular surface 220. The attachment 200 also defines inner cavities (not shown in FIG. 2A or 2B) configured to fit around/over bolt heads or other fasteners that may be used to secure the tooling 100 to a robot arm. Bulge surfaces 222 may be positioned in between the cylindrical surface 210 and annular surface 220, corresponding to locations of the inner fastener cavities of the attachment 200. A rear-facing planar surface 224 (see FIG. 2B) is also positioned between the cylindrical surface 210 and lateral planar surface 218. Furthermore, curved surface 226 is positioned in between the rear-facing planar surface 224 and the rear-facing planar surface 214. Curved surface 228 is positioned between the rear-facing planar surface 224 and an additional rear-facing planar surface 230. The attachment 200 may be formed symmetrically with respect to the cylindrical surface 210, and as such the illustrated example comprises surfaces on the opposite sides to those shown in FIG. 2A, and which correspond to the surfaces such as left lateral curved surface 206a, left lateral planar surface 208a, rear-facing planar surface 212a, etc. which are not visible in FIG. 2A.

In the illustrated example, the outer surfaces 202, 204, 206, 208, 210, 212, 214, 216, 218, 220, 222, 224, 226, 228, and 230 of the attachment 200 are continuous and free of voids, seams, or openings that might otherwise collect cooking mediums such as oil, food particles, or harbor bacteria. Each of these surfaces 202-230 is configured to directly interface with and cover openings or moving components of the tooling 100. Merely as examples, surface 202 may be in contact with supports 110a and 110b, which as noted above may move toward each other or away from each other by way of the slides 114a and 114b, respectively. The surface 202 also generally covers the tracks 116a and 116b, preventing contact with food particles, spatter from oil or other cooking mediums, etc. Additionally, lateral surfaces 206 and 208 each cover ends of the tracks 116a and 116b.

As noted above, the attachment 200 may be formed of a generally flexible material, e.g., food-safe silicone, to allow removal of the attachment 200 from the tooling 100 for cleaning. Further, the attachment 200 may have at least one opening that allows the plurality of surfaces to be removably attached to the automated tooling 100 such that the plurality of surfaces may selectively directly interface and cover the components of the automated tooling 100.

For example, referring now to FIG. 3 the attachment 200 is illustrated after removal from the tooling 100 (not shown in FIG. 3). An opening 302 is depicted in FIG. 3 extending longitudinally along the cylindrical surface 210. Accordingly, the attachment 200, being formed of a flexible material, may be flexed to facilitate removal from and installation to the tooling 100. The opening 302 extends along a lower side of the attachment 200 such that the attachment 200 can be flexibly pulled over the automated tooling 100 (not shown in FIG. 3). More specifically, the attachment 200 may be elastically deformed by pulling cylindrical surface 210 apart along the opening 302, allowing the attachment 200 to be pulled over upon the tooling 100. Further, the opening 302 extends along a location of the tooling that is suitable for cleaning and sterilization, i.e., a lower surface of the tooling 100 that is more accessible for application of cleaning or sterilizing fluid, or less likely to accumulate food particles, spatter from cooking oil, etc. Nevertheless, in some implementations the automated tooling attachment may entirely enclose the geometry of interest of the tooling 100, such as by clasps, latches, overlapping seam, fasteners, or other similar features (not shown). Furthermore, while the illustrated attachment 200 is generally formed of a single monolithic piece as noted above, in other approaches additional materials or a multi-piece construction may be employed, e.g., where additional materials or pieces are attached, and which have additional one or more additional surface(s) configured to directly interface with and cover another component of the automated tooling 100. As another example, multiple pieces may be utilized such that each of the openings of the pieces are covered or expose a closed portion of the other piece, such that no portion of the tooling is accessible via the openings when the pieces are installed. Additional materials or parts may be attached, merely as examples, using a clasp, latch, overlapping seam, or fastener.

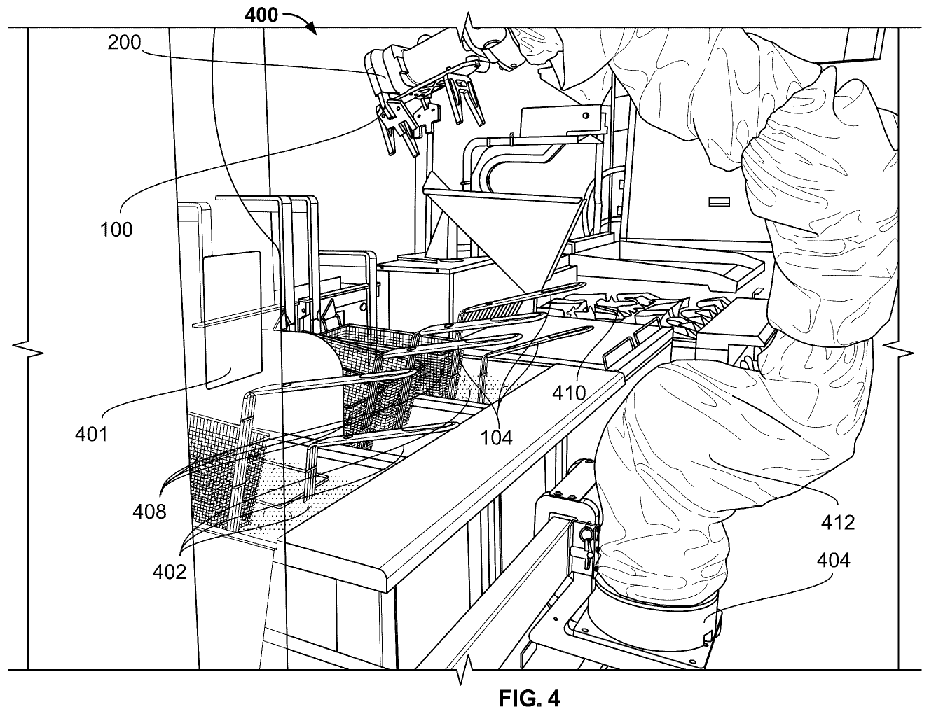

FIG. 4 depicts a perspective view of an automated cooking system 400 comprising a robot arm 404 carrying tooling 100 as a food preparation device. Further, the tooling 100 is shown covered by the attachment 200. Generally, the system 400 is directed to an automated food preparation or cooking system comprising a plurality of fryers 402, each configured to cook bulk consumable items such as French fries, chicken nuggets, or the like. The system 400 includes one or more multi-axis robotic arm(s) 404 configured to interface with the fryer 402. Tooling 100 is secured to an end of the robot arm 404. Tooling 100, as described above, is configured to grip or manipulate a handle 104 of any of a number of baskets 408 in the system 400. Accordingly, the robot arm 404 may be configured to grab, move, and release the fryer baskets 408 as needed to collect raw bulk food items from a dispenser 401 and to move the food items to the fryer 402 for cooking. For example, the tooling 100 may release the handle 104 after bringing the basket to the fryer 402, allowing the basket(s) 408 to descend into a respective fryer 402. After cooking, the basket 408 may be elevated out of a cooking medium, e.g., oil, within the fryer. Robot arm 404 may grasp the handle 104 again using the tooling 100, and move the basket to a position where the bulk food items may be dumped to a holding station 410. The holding station 410 may provide heat to maintain warmth of the cooked bulk food items, and may also facilitate seasoning of the cooked bulk food items. The robot arm 404 may be configured to move in response to the tooling 100 transmitting an indication that the gripper assembly 108 has enclosed or released the handle 104, e.g., to processing circuitry of the robot arm 404 or other components of the system. Additionally, the robot arm 404 may have an outer cover 412 configured to protect the robot arm 404 from spatter from the cooking medium within the fryer(s) 402, from food particles, etc. The cover 412 may be removable from the robot arm 404 for disposal and/or cleaning.

As described above and as shown in FIGS. 2A, 2B, and FIG. 4, while the surfaces 202-230 (see FIGS. 2A and 2B) of the attachment 200 may continuously cover an upper portion of the tooling 100, at least some portion(s) of the tooling 406 may remain uncovered or exposed during use of the tooling 406. For example, portions of gripper assembly 108 are not covered by any of the plurality of surfaces 202-230 of the attachment 200. More specifically, lower portions of the supports 110a and 110b, as well as the lateral grips 112a and 112b, protrude from the attachment 200. Furthermore, the extensions 102a and 102b are uncovered. These uncovered portions of the tooling 100 may correspond to areas of the tooling 100 necessary to directly interface with other components of the automated cooking system 400. For example, the lateral grips 112a and 112b, as well as the extensions 102a and 102b may directly contact the handle 104 (e.g., as shown in FIGS. 1A-1C) when the tooling 100 is gripping the handle 104, e.g., while manipulating an associated basket of bulk food items. Accordingly, the attachment 200 protects areas of the tooling 100 not required to directly contact other components of an automated cooking system or other external objects, while allowing unimpeded use of other areas of the tooling 100 needed to perform desired or essential functions of the tooling 100 within an automated cooking system.

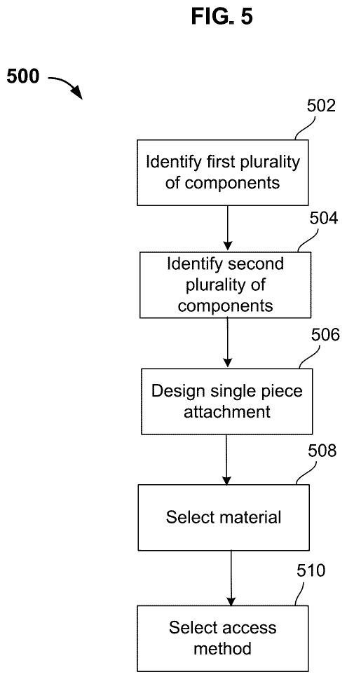

Referring now to FIG. 5, an example process 500 of designing an attachment for an automated tooling is illustrated and described in further detail. Process 500 may begin at block 502, where a first plurality of components of the automated tooling are identified that are required to be covered by the attachment. For example, as discussed above, portions of the tooling 100 may have moving components or openings, voids, or seams that may collect debris or otherwise would require periodic cleaning after operation. Further, at least some of the components may be identified as not needing direct contact with elements of the system in which the tooling functions, e.g., with handle 104 of baskets 408.

Proceeding to block 504, process 500 may identify a second plurality of components of the automated tooling that are not required to be covered. For example, components of tooling 100 that are relatively easily cleaned (to the extent cleaning is required) or which require direct contact with other elements of the automated cooking system 400, e.g., lateral grips 112 and/or extensions 102, may be left uncovered by an attachment. Process 500 may then proceed to block 506.

At block 506, an attachment (e.g., single or multi-piece) may be designed that directly interfaces with and covers the first plurality of components, while not covering or directly interfacing with at least some of the second plurality of components. For example, attachment 200 described above directly interfaces with moving components such as the slides 114 and covers tracks 116 of the tooling 100. Further, lower portions of the supports 110, the lateral grips 112, and the extensions 102 are uncovered by the attachment. Process 500 may then proceed to block 508.

At block 508, a material suitable for attachment of the single piece attachment over the first plurality of components may be selected. In the example attachment 200 described above, a relatively flexible silicone materials is selected that is resistant to high temperatures (e.g., up to 350 degrees Fahrenheit or other temperatures typical of frying bulk food items).

Proceeding to block 510, an access method for the single piece is selected to facilitate attachment over the first plurality of components. In the example attachment 200, a single opening 302 is selected and defined that allows the attachment 200 to be elastically flexed open to place over the tooling 100. It should be noted that the access method may be determined at least in part based upon a material selected. Accordingly, to the extent a relatively stiffer material or configuration of the attachment is selected, additional allowances may be required to allow installation and removal of the attachment. Process 500 may then terminate.

The example attachment 200 and process 500 for designing the same facilitates covering of an automated tooling, e.g., tooling 100, which allows advantages of a mechanical system as well as cleanability. For example, the attachment 200 may be periodically removed during non-use of an automated cooking system, washed or cleaned, and reinstalled. Furthermore, to the extent other components may require periodic washing or cleaning, the attachment 200 may be washed along with any other components that require regular cleaning, e.g., in an automated washer or other cleaning system. The attachment 200 and process 500 may thereby facilitate certification of an automated cooking system by standard-setting bodies such as NSF and the like.

The foregoing is merely illustrative of the principles of this disclosure and various modifications may be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications. The disclosed subject matter should not be limited to any single embodiment described herein, but rather should be construed according to the claims.

What is claimed is:

1. An attachment for automated tooling of a food preparation device, comprising:
a plurality of surfaces, each of a single piece of material, wherein each of the plurality of surfaces is configured to directly interface with and cover a component of the automated tooling, comprising:
a first surface of the plurality of surfaces configured to cover one or more moving components of the automated tooling; and
a second surface of the plurality of surfaces configured to cover one or more openings of the automated tooling; and
at least one attachment opening that allows the plurality of surfaces to be removably attached to the automated tooling such that the plurality of surfaces each directly interfaces with and covers the component of the automated tooling.

2. The attachment of claim 1, wherein a material of the attachment is a flexible material.

3. The attachment of claim 2, wherein the flexible material comprises one of a flexible elastomer, resin, polymer, silicon, thermoplastic, rubber, or thermoplastic polyurethane (TPU).

4. The attachment of claim 2, wherein the attachment opening extends along a side of the attachment such that the attachment can be flexibly pulled over the automated tooling.

5. The attachment of claim 1, wherein the automated tooling comprises an end-of-arm tool that attaches to a robot arm.

6. The attachment of claim 5, wherein the end-of-arm tool comprises a gripper assembly.

7. The attachment of claim 6, wherein a lateral grip of the gripper assembly is not covered by any of the plurality of surfaces when the attachment is installed on the automated tooling.

8. The attachment of claim 6, wherein the gripper assembly is configured to grip a handle of a fry basket.

9. An automated tooling of a food preparation system, comprising:
a plurality of assembled components including at least one moving component, wherein the plurality of assembled components define one or more openings;
an attachment comprising a plurality of surfaces, each of a single piece of material, wherein each of the plurality of surfaces is configured to directly interface with and cover one of the assembled components of the automated tooling, comprising:
a first surface of the plurality of surfaces configured to cover the at least one moving component; and
a second surface of the plurality of surfaces configured to cover one or more of the one or more openings;
wherein the attachment defines at least one attachment opening that allows the plurality of surfaces to be removably attached to the automated tooling such that the plurality of surfaces each directly interfaces with and covers the one of the assembled components of the automated tooling.

10. The automated tooling of claim 9, wherein the automated tooling is configured to be attached to a robot arm.

11. The automated tooling of claim 9, wherein the plurality of assembled components comprises a gripper assembly, the at least one moving component comprising a first lateral grip and a second lateral grip of the gripper assembly, the first lateral grip and the second lateral grip configured to enclose and grip an elongate handle.

12. The automated tooling of claim 11, wherein the first lateral grip and the second lateral grip are configured to translate toward each other to grip the elongate handle.

13. The automated tooling of claim 11, wherein at least one of the first and second lateral grips is not covered by any of the plurality of surfaces when the attachment is installed on the automated tooling.

14. The automated tooling of claim 11, wherein the one or more openings include a track, and wherein one of the first and second lateral grips is configured to translate with a slide positioned within the track.

15. The automated tooling of claim 11, wherein the plurality of assembled components includes one or more extensions defining an opening configured to receive the elongate handle.

16. The automated tooling of claim 15, wherein the first and second lateral grips are configured to grip the elongate handle against a clamp surface positioned within the opening of the one or more extensions.

17. The automated tooling of claim 15, wherein the one or more extensions comprise a first extension and a second extension, and the first and second lateral grips are each positioned in between the first extension and the second extension.

18. The automated tooling of claim 9, wherein a material of the attachment is a flexible material, wherein the flexible material comprises one of a flexible elastomer, resin, polymer, silicon, thermoplastic, rubber, or thermoplastic polyurethane (TPU).

19. The automated tooling of claim 9, wherein the attachment opening extends along a side of the attachment such that the attachment can be flexibly pulled over the automated tooling.

20. A method of designing an attachment for automated tooling, comprising:
identifying a first plurality of components of the automated tooling that are required to be covered;
identifying a second plurality of components of the automated tooling that are not required to be covered;
designing a single piece attachment that directly interfaces with and covers the first plurality of components, wherein the single piece attachment does not directly interface and cover at least some of the second plurality of components;
selecting a flexible material suitable for attachment of the single piece attachment over the first plurality of components; and
defining an opening for the single piece attachment to be attached over the first plurality of components.
